(19) United States
(12) Patent Application Publication
(10) Pub. No.: US 2010/0028114 A1
(43) Pub. Date: Feb. 4, 2010

(54) MOVING HEADBOARD TRAILER EJECTOR AND FLOOR CLEANING APPARATUS

(76) Inventor: LARRY BUTTERFIELD, Clay Center, KS (US)

Correspondence Address: CORNELIUS P. DUKELOW;ABINGTON INTELLECTUAL PROPERTY LAW GROUP, PC, 10026-A S, MINGO ROAD, NO. 240, TULSA, OK, 74133, US

(21) Appl. No.: 12/184,470

(22) Filed: Aug. 1, 2008

(51) Int. Cl. B65G 67/26; B60P 1/00; B65D 88/60

(52) U.S. Cl. 414/510; 414/539; 414/521; 414/509

(57) ABSTRACT

The present invention relates to a detachably attachable moving headboard trailer ejector and floor cleaning apparatus for use with a self-unloading trailer having a front end, a rear end, side walls, and either a reciprocating slat conveyor floor or a conveyor belt floor. The invention comprises, in one embodiment, a base, a panel sweeper, one or more panel sweeper support members, a means for traversing the panel sweeper, a tether bar, side flanges, and a base flange. In use, the invention is placed in the front end of a self-unloading trailer and the trailer is loaded with material; when material is ejected from the trailer, the invention “rides” along the moving floor and pushes the material out of the trailer's back end. The rubber flanges ensure a snug fit within the trailer and keep post ejection residual material at a minimum.

### CROSS-REFERENCE TO RELATED APPLICATIONS

None.

### STATEMENT REGARDING FEDERALLY SPONSORED RESEARCH OR DEVELOPMENT

None.

### THE NAMES OF THE PARTIES TO A JOINT RESEARCH AGREEMENT

None.

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

None.

### BACKGROUND OF THE INVENTION

1. Field of the Invention

The present invention relates generally to devices for ejecting bulk materials from trailers. More particularly, the present invention relates to a detachably attachable moving headboard trailer ejector and floor cleaning apparatus for use with a self-unloading trailer having a front end, a rear end, side walls, and either a reciprocating slat conveyor floor or a conveyor belt floor.

2. Description of Related Art

Many bulk commodities and aggregates are transported throughout the United States by various types of trailers, including transport semi-trailers. Materials commonly moved include, but are not limited to, dirt, sand, rock, grain, etc. A truck operator is paid to move material from one location to another - the more material an operator can move in a given period of time, the more profitable the operator's business will be.

Many transport trailers used by operators are of the “self-unloading” type. Self-unloading trailers use one of several forms of “moving floors” to eject material from the trailer. Moving floors come in various forms including, but not limited to, reciprocating slat floors and conveyor belt floors. By their automation, these floors substantially decrease the time required to eject material from trailers compared to manual ejection methods. One time consuming drawback of a moving floor, however, is that after ejecting transported material from the trailer, some amount of residual transported material often remains on the trailer floor—material that must be manually swept or shoveled out of the trailer. Removing residual material from a trailer takes time, which increases the total transport time and reduces the operator's profit.

### BRIEF SUMMARY OF THE INVENTION

The present invention relates to a detachably attachable moving headboard trailer ejector and floor cleaning apparatus for use with a self-unloading trailer having a front end, a rear end, side walls, and either a reciprocating slat conveyor floor or a conveyor belt floor. The invention comprises, in one embodiment, a base, a panel sweeper, one or more panel sweeper support members, a means for traversing the panel sweeper, a tether bar, side flanges, and a base flange.

In use, the invention is placed in the front end of a self-unloading trailer and the trailer is loaded with material; when the moving floor is activated and material is ejected from the trailer, the invention “rides” along the moving floor and pushes the material out of the trailer's back end. The rubber flanges ensure a snug fit within the trailer and keep post ejection residual material at a minimum. After ejection is complete, the apparatus may be pushed back into place or pulled back into place via the tether bar. The invention may be used with most self-unloading trailers and does not require retrofitting of trailers for proper use. The “means for traversing the panel sweeper” may include a hinged door, a horizontally sliding panel, or a vertically sliding panel and gives the operator access to the trailer area behind the apparatus without the need to climb over the apparatus and risk injury.

### BRIEF DESCRIPTION OF THE SEVERAL VIEWS OF THE DRAWING

A preferred embodiment of the present invention is described in detail below with reference to the attached drawing figures, wherein:

FIG. 1 illustrated an exploded perspective view of one embodiment of the invention.

FIG. 2 illustrates a perspective view of one embodiment of the invention.

FIG. 3 illustrates a side view of one embodiment of the invention in use.

FIG. 4 illustrates an additional side view of one embodiment of the invention in use.

FIG. 5 illustrates a front view of one embodiment of the invention in a trailer.

FIG. 6 illustrates a rear view of one embodiment of the invention in a trailer.

FIG. 7 illustrates a front view of one embodiment of the invention in a trailer and in use.

### DETAILED DESCRIPTION OF THE INVENTION

The embodiments discussed herein are merely illustrative of specific manners in which to make and use the invention and are not to be interpreted as limiting the scope of the instant invention.

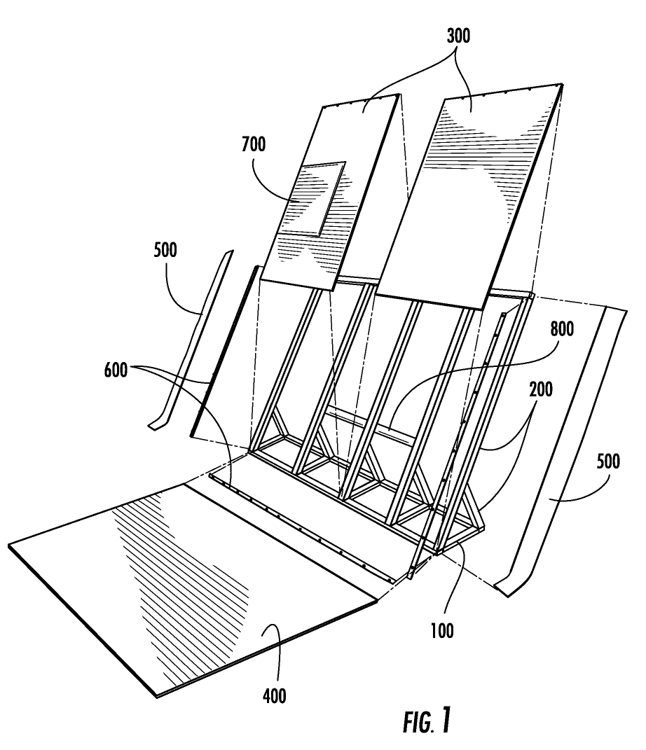

Referring to the drawings in detail, FIG. 1 illustrates an exploded perspective view of one embodiment of the invention. A rectangular base member 100 with support members 200 mounted thereon supports the panel sweeper 300. In the preferred embodiment, the base and support members are made of aluminum; the base and support members may, however, be formed of any other appropriate material capable of achieving the desired form and performing the desired function including, but not limited to, plastic, metal, or wood. In the preferred embodiment the panel sweeper is sheet metal; the panel sweeper may, however, be formed of any other appropriate material capable of achieving the desired form and performing the desired function including, but not limited to, plastic, metal, or wood. A base flange 400 and two side flanges 500 are mounted onto the panel sweeper at the bottom and sides of the panel sweeper respectively. In the preferred embodiment, the flanges are made of rubber; the flanges may, however, be formed of any other appropriate material capable of achieving the desired form and performing the desired function. In the present embodiment, the flanges are mounted onto the panel sweeper via a plate and screw assembly 600, the flanges may also be mounted by any other appropriate means including, but not limited to a plate and rivet assembly, adhesives, or mounting the flanges between the panel sweeper and support members. A means for traversing the panel sweeper 700 may include a hinged door, a horizontally sliding panel, or a vertically sliding panel and provides access to the trailer area behind the apparatus without the need to climb over the apparatus and risk injury. A tether bar 800 is mounted between the support members. In an alternate embodiment, the tether bar may be mounted on the back portion of the panel sweeper itself. In the preferred embodiment, the tether bar is made of aluminum; the tether bar may, however, be formed of any other appropriate material capable of achieving the desired form and performing the desired function including, but not limited to, plastic, metal, or wood.

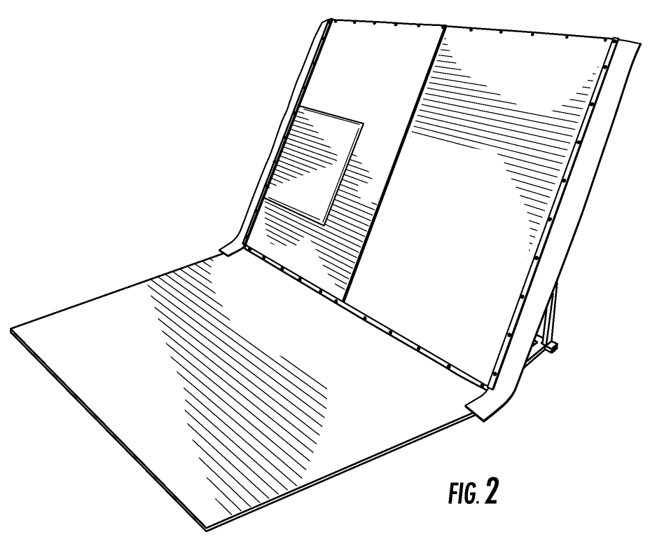

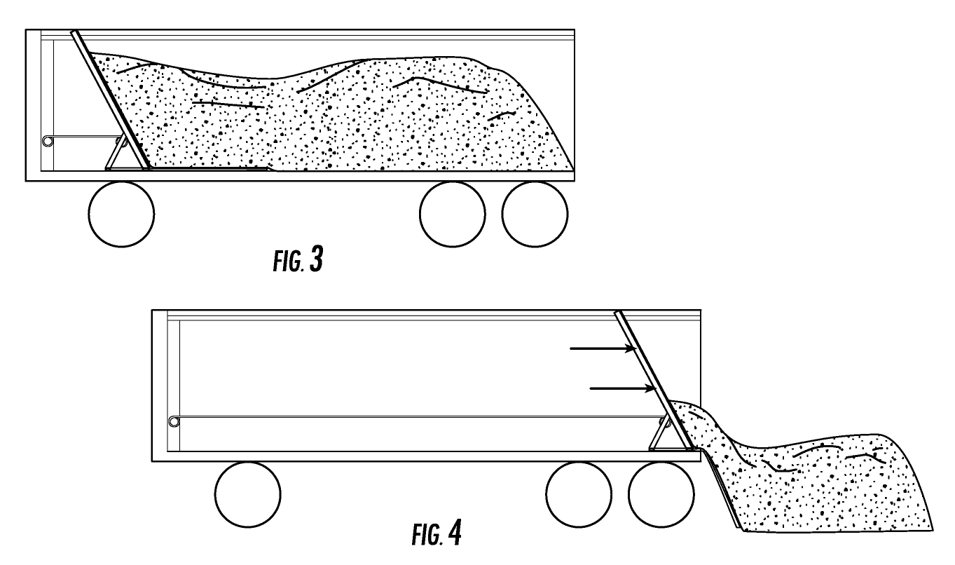

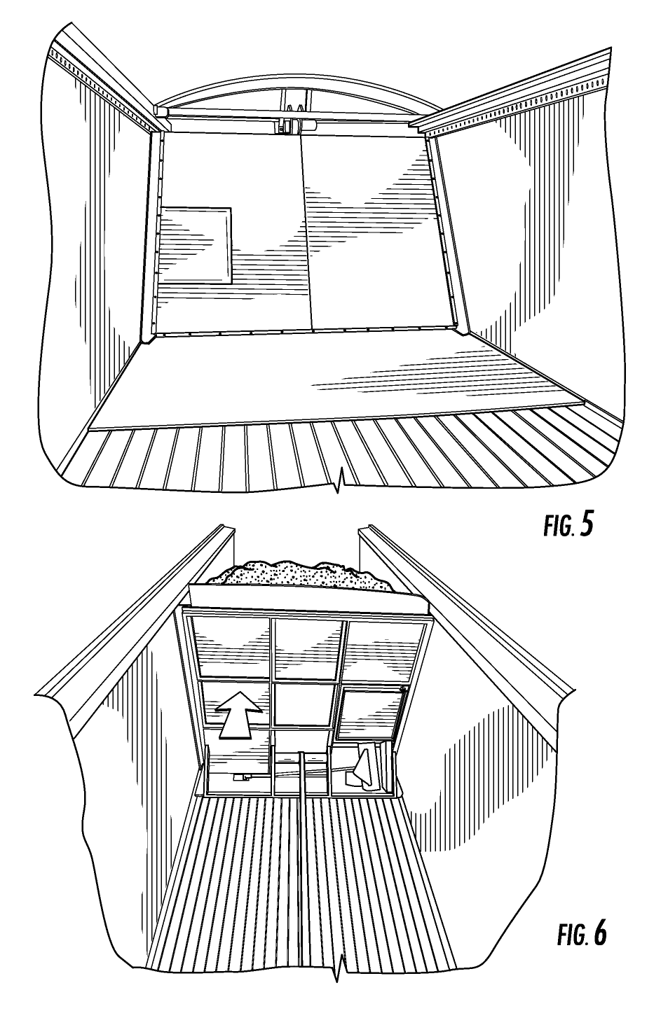

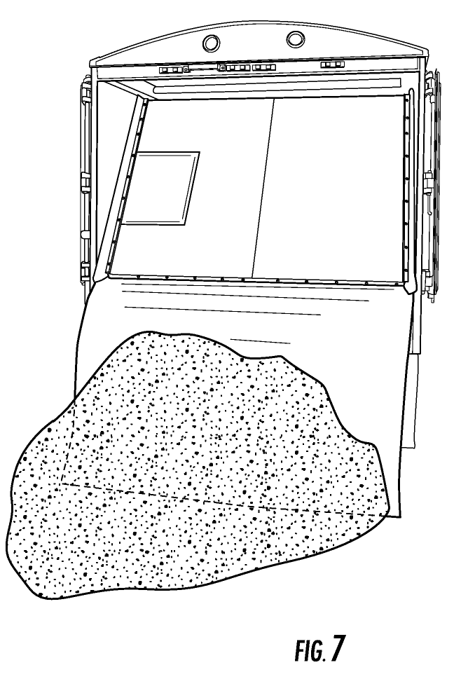

FIG. 2 illustrates a perspective view of one embodiment of the invention in its assembled state. FIG. 3 illustrates the invention in the bed of a self-unloading trailer that has been filled with material in a position ready to be unloaded. FIG. 4 illustrates the invention in the bed of a self-unloading trailer and in the process of ejecting material therefrom. FIG. 5, FIG. 6, and FIG. 7 illustrate additional views of the invention in the bed of a self-unloading trailer and in use.

While the invention has been described with a certain degree of particularity, it is to be noted that modifications may be made in the details of the invention's construction and the arrangement of its components without departing from the spirit and scope of this disclosure. It is understood that the invention is not limited to the embodiments set forth herein for the purposes of exemplification.

The invention claimed is:

1. A trailer ejector and floor cleaning apparatus, comprising:
a rectangular base having a top portion, a bottom portion, a front end, a back end, and two sides;
a panel sweeper having a front portion, a back portion, a top end, a bottom end, and two sides mounted on said top portion of said base nearest said front end of said base;
one or more support members mounted on said top portion of said base and intersecting said back portion of said panel sweeper in support thereof;
a base flange mounted on said front portion of said panel sweeper nearest said bottom end of said panel sweeper and extending outwardly therefrom; and
a pair of side flanges mounted on said front portion of said panel sweeper nearest said sides of said panel sweeper and extending outwardly therefrom.

2. A trailer ejector and floor cleaning apparatus as recited in claim 1, further comprising:
a means for traversing said panel sweeper.

3. A trailer ejector and floor cleaning apparatus as recited in claim 1, further comprising:
a tether bar mounted on said back portion of said panel sweeper.

4. A trailer ejector and floor cleaning apparatus, comprising:
a rectangular base having a top portion, a bottom portion, a front end, a back end, and two sides;
a panel sweeper having a front portion, a back portion, a top end, a bottom end, and two sides mounted on said top portion of said base nearest said front end of said base;
one or more support members mounted on said top portion of said base and intersecting said back portion of said panel sweeper in support thereof;
a base flange mounted on said front portion of said panel sweeper nearest said bottom end of said panel sweeper and extending outwardly therefrom;
a pair of side flanges mounted on said front portion of said panel sweeper nearest said sides of said panel sweeper and extending outwardly therefrom; and
a tether bar mounted on said back portion of said panel sweeper.

5. A trailer ejector and floor cleaning apparatus as recited in claim 4, further comprising:
a means for traversing said panel sweeper.

6. A trailer ejector and floor cleaning apparatus, comprising:
a rectangular base having a top portion, a bottom portion, a front end, a back end, and two sides;
a panel sweeper having a front portion, a back portion, a top end, a bottom end, and two sides mounted on said top portion of said base nearest said front end of said base;
one or more support members mounted on said top portion of said base and intersecting said back portion of said panel sweeper in support thereof;
a base flange mounted on said front portion of said panel sweeper nearest said bottom end of said panel sweeper and extending outwardly therefrom;
a pair of side flanges mounted on said front portion of said panel sweeper nearest said sides of said panel sweeper and extending outwardly therefrom;
a tether bar mounted on said back portion of said panel sweeper; and
a means for traversing said panel sweeper.
